(19) United States
(12) Patent Application Publication
(10) Pub. No.: US 2021/0152507 A1
(43) Pub. Date: May 20, 2021

(54) SYSTEM AND METHOD FOR SECURE PROCESSING OF DATA

(71) Applicant: Gregory Pengiel, Woodridge, IL (US)

(72) Inventor: Gregory Pengiel, Woodridge, IL (US)

(21) Appl. No.: 16/683,797

(22) Filed: Nov. 14, 2019

(51) Int. Cl. H04L 12/58; H04L 29/06; H04L 29/08

(52) U.S. Cl. CPC H04L 51/18; H04L 63/0846; H04L 2463/082; H04L 51/08; H04L 67/22

(57) ABSTRACT

A computer system for secure processing of data. A request is received from a plurality of sources to provide data through a search module. The data matched with the received request is retrieved through a retrieval module. The data is retrieved from a plurality of resources. The request is split into a plurality of tasks assigned to users through an assignment module. The assignment module assigns the task by performing a two-factor authentication by the user through an email. Furthermore, transmitting of documents pertaining to the requested data to the authenticated user through a transmission module and tracking a plurality of viewing activities of the user.

This application claims priority from provisional application No. 62/768,755, filed Nov. 16, 2018, the entire contents of which are herewith incorporated by reference.

### TECHNICAL FIELD

The present invention relates to secure data processing, in particular to a system and method for secure communication of sensitive data.

### BACKGROUND

Typically, email and other mediums of electronic communication can be potential sources of security threats and vulnerabilities. These threats and can include, for example, not only through the introduction of malware (e.g., via email attachments, etc.) but also from the standpoint of accidental and malicious disclosures of confidential and other sensitive data via email.

For example, email is a frequently used tool to communicate important information, documents, and files between and within organizations. While email communication is secure, it has limitations to handle the documents, type of users that communicate, the type of information that can be captured, and finally how it audits information. Further, users have limits in terms of the size of the documents they share. The users also have to be known to the secure system. Finally, critical messages and information can be compromised in case the users send the documents outside the system without being audited.

Thus, in view of the above, there is a long-felt need in the industry to address the aforementioned deficiencies and inadequacies.

Further limitations and disadvantages of conventional and traditional approaches will become apparent to one of skill in the art through comparison of described systems with some aspects of the present disclosure, as set forth in the remainder of the present application and with reference to the drawings.

### SUMMARY OF THE INVENTION

The present invention mainly solves the technical problems existing in the prior art. In response to these problems, the present invention provides a system and method for secure processing of data.

The inventor recognized that there is a need for an efficient, elegant and effective system and method for secure processing of data over email. Further, there is a need for a system and method which can function for documents of any size and audit the information which is supposed to be shared outside of the present system.

An aspect of the present disclosure relates to a method for secure processing of data. The method comprises a step of receiving a request from a plurality of sources to provide data through a search module. Then the method comprises a step of retrieving the data matched with the received request through a retrieval module. The data is retrieved from a plurality of resources. The method then includes a step of splitting the request into a plurality of tasks assigned to a plurality of users through an assignment module. The assignment module assigns the task by performing a two-factor authentication by the user through an email. The users receive an email having a link to provide the data pertaining to the task. The link prompts the user to enter a unique code. The unique code is transmitted to the email of the user assigned to a specific task. Furthermore, the method comprises a step of transmitting one or more documents pertaining to the requested data to the authenticated user through a transmission module and tracking a plurality of viewing activities of the user.

The method further comprises a step of recording a plurality of actions of the user through a logging module.

In an aspect, the unique code validates the user and allows the user to view and update the task.

In an aspect, the present method provides the data to the user in a predefined template and receives the request from the user in a predefined format.

An aspect of the present disclosure relates to a device in a network. The device includes a non-transitory storage device having embodied therein one or more routines operable to perform secure processing of data. The one or more routines include a search module, a retrieval module, an assignment module, and a transmission module.

The search module is configured to receive a request from a plurality of sources to provide data. The retrieval module is configured to retrieve the data matched with the received request. The data is retrieved from a plurality of resources. The assignment module is configured to split the request into a plurality of tasks assigned to a plurality of users. The assignment module assigns the task by performing a two-factor authentication by the user through an email. The users receive an email having a link to provide the data pertaining to the task. The link prompts the user to enter a unique code. The unique code is transmitted to the email of the user assigned to a specific task. The transmission module is configured to transmit one or more documents pertaining to the requested data to the authenticated user, and further track a plurality of viewing activities of the user.

An aspect of the present disclosure relates to a system for secure processing of data. The system includes a processor and a memory. The memory stores machine-readable instructions that when executed by the processor cause the processor to receive a request from a plurality of sources to provide data through a search module. The processor is further configured to retrieve the data matched with the received request through a retrieval module. The data is retrieved from a plurality of resources. The processor is then configured to split the request into a plurality of tasks assigned to a plurality of users through an assignment module. The assignment module assigns the task by performing a two-factor authentication by the user through an email. The users receive an email having a link to provide the data pertaining to the task. The link prompts the user to enter a unique code. The unique code is transmitted to the email of the user assigned to a specific task. The processor is then configured to transmit one or more documents pertaining to the requested data to the authenticated user through a transmission module, and further tracking a plurality of viewing activities of the user.

Accordingly, one advantage of the present invention is that it functions for documents of any size and not be subject to the typical constraints imposed by standard secure email.

Accordingly, one advantage of the present invention is that it provides a structured template for delivering information to the user and capturing the information from the users.

Accordingly, one advantage of the present invention is that it allows the users to send requests for information need to be shared outside the present system and inside the present system.

Other features of embodiments of the present disclosure will be apparent from accompanying drawings and from the detailed description that follows.

Yet other objects and advantages of the present invention will become readily apparent to those skilled in the art following the detailed description, wherein the preferred embodiments of the invention are shown and described, simply by way of illustration of the best mode contemplated herein for carrying out the invention. As we realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description applies to any one of the similar components having the same first reference label irrespective of the second reference label.

FIG. 1 illustrates a block diagram of the present system for secure processing of data, in accordance with an embodiment of the present invention.

FIG. 2 illustrates a network architecture of the present invention, in accordance with an embodiment of the present invention.

FIG. 3 illustrates an exemplary operational screenshot of the authentication process of the present invention, in accordance with an embodiment of the present invention.

FIG. 4 illustrates an exemplary operational screenshot of a plurality of steps to resolve the request, in accordance with an embodiment of the present invention.

FIG. 5 illustrates an exemplary operational screenshot of a plurality of steps to configure the request template, in accordance with an embodiment of the present invention.

FIG. 6 illustrates a flowchart of the method for secure processing of data, in accordance with an embodiment of the present invention.

### DETAILED DESCRIPTION OF THE ILLUSTRATIVE EMBODIMENTS

The present disclosure is best understood with reference to the detailed figures and description set forth herein. Various embodiments have been discussed with reference to the figures. However, those skilled in the art will readily appreciate that the detailed descriptions provided herein with respect to the figures are merely for explanatory purposes, as the methods and systems may extend beyond the described embodiments. For instance, the teachings presented and the needs of a particular application may yield multiple alternative and suitable approaches to implement the functionality of any detail described herein. Therefore, any approach may extend beyond certain implementation choices in the following embodiments.

Systems and methods are disclosed for secure processing of data over email. Embodiments of the present disclosure include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, firmware, and/or by human operators.

Embodiments of the present disclosure may be provided as a computer program product, which may include a machine-readable storage medium tangibly embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more machine-readable storage media containing the code according to the present disclosure with appropriate standard computer hardware to execute the code contained therein. An apparatus for practicing various embodiments of the present disclosure may involve one or more computers (or one or more processors within a single computer) and storage systems containing or having network access to computer program(s) coded in accordance with various methods described herein, and the method steps of the disclosure could be accomplished by modules, routines, subroutines, or subparts of a computer program product.

The present invention discloses a system and method whereby a framework is used to send the documents that authenticate the user and tracks their view activity. The embodiments function for documents of any size and are not be subject to the typical constraints imposed by the standard secure email. Access to the information requires a two-factor authentication by the user. The present system logs and stores every action. Most importantly, the system provides a structured template for delivering information to the user and captures information from the users.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular name.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail to avoid obscuring the embodiments.

The term “machine-readable storage medium” or “computer-readable storage medium” includes, but is not limited to, portable or non-portable storage devices, optical storage devices, and various other mediums capable of storing, containing, or carrying instruction(s) and/or data. A machine-readable medium may include a non-transitory medium in which data can be stored, and that does not include carrier waves and/or transitory electronic signals propagating wirelessly or over wired connections. Examples of a non-transitory medium may include but are not limited to, a magnetic disk or tape, optical storage media such as compact disk (CD) or versatile digital disk (DVD), flash memory, memory or memory devices.

Although the present subject matter is explained considering that the present system is implemented on a server, it may be understood that the present system may also be implemented in a variety of computing systems, such as a laptop computer, a desktop computer, a notebook, a workstation, a mainframe computer, a server, Amazon elastic compute cloud (Amazon EC2), Microsoft Azure, a network server, and the like. It will be understood that multiple users may access the present system through one or more computing devices. Examples of the computing devices may include but are not limited to, a portable computer, a personal digital assistant, a handheld or mobile device, smart devices, and a workstation. The computing devices are communicatively accessible to the present system through a network.

In one implementation, the network may be a wireless network, a wired network or a combination thereof. The network can be implemented as one of the different types of networks, such as an intranet, local area network (LAN), wide area network (WAN), the internet, and the like. The network may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the network 106 may include a variety of network devices, including routers, bridges, servers, computing devices, storage devices, and the like.

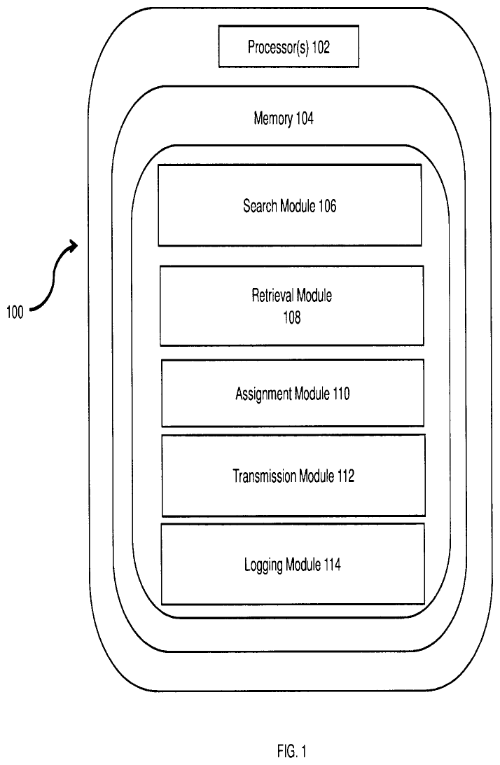

FIG. 1 illustrates a block diagram of the present system 100 for secure processing of data, in accordance with an embodiment of the present invention. The system 100 includes a processor 102 and a memory 104. The memory 104 stores machine-readable instructions that when executed by the processor 102 cause the processor 102 to receive a request from a plurality of sources to provide data through a search module 106. The processor 102 is further configured to retrieve the data matched with the received request through a retrieval module 108. The data is retrieved from a plurality of resources.

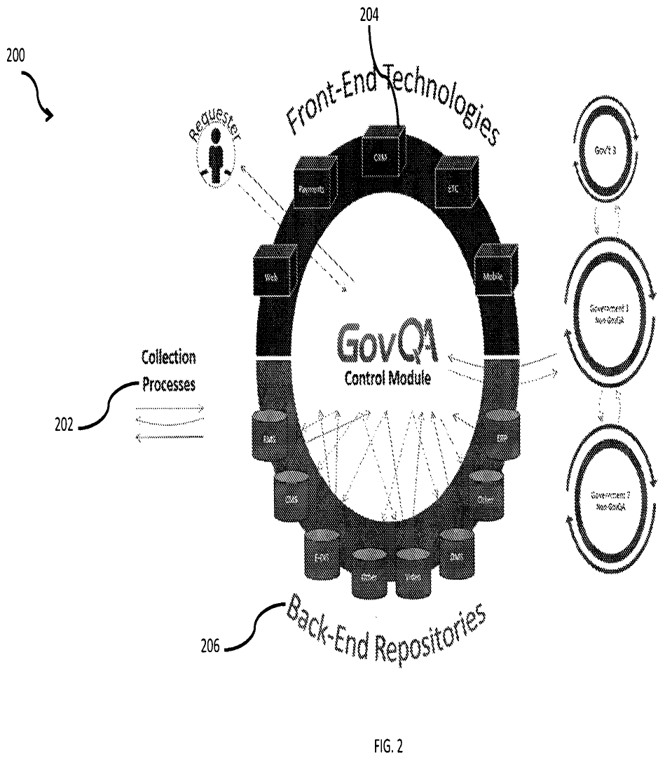

FIG. 2 illustrates a network architecture 200 of the present invention, in accordance with an embodiment of the present invention. The network architecture utilizes “collect and control” platform, and it allows the users to send the requests for information outside the present system and inside the present system. The requests for information are initiated from various sources, including but not limited to CRM systems 204, payment systems, websites, etc. These requests are channeled into the present system 100 which will then pull information and “collect” that information, using processes 202, for further processing. The requested information can be retrieved from a number of different repositories 206 including, but not limited to, databases, document management systems, records management systems, etc.

The processor 102 operates to split the request into a plurality of tasks assigned to a plurality of users through an assignment module 110. In operation, the present system splits the requests into multiple “activities” or tasks. These “activities” or tasks can be assigned to users in the present system, individuals that use the present system for other agencies, or the users that do not use the present system at all.

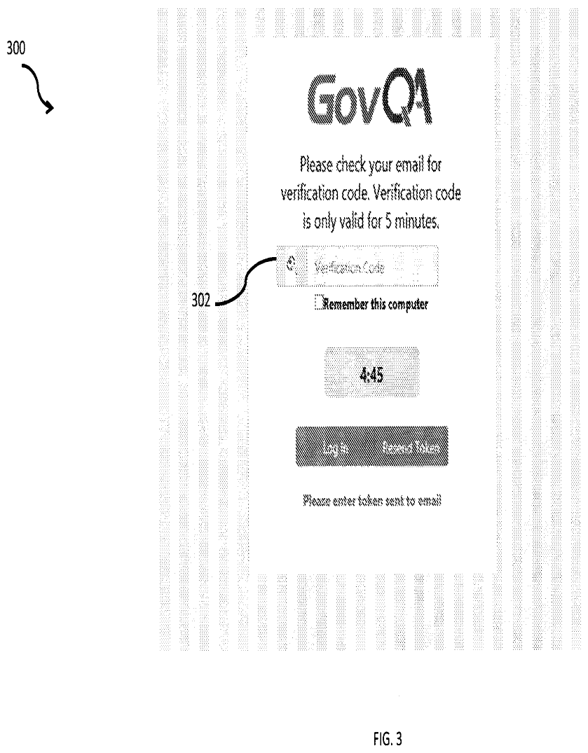

FIG. 3 illustrates an exemplary operational screenshot 300 of the authentication process of the present invention, in accordance with an embodiment of the present invention. The assignment module 110 assigns the task by performing a two-factor authentication by the user through an email. The users receive an email having a link to provide the data pertaining to the task. The link is prompted the user to enter 302 a unique code. In an embodiment, the unique code validates the user and allows the user to view and update the task. The unique code is transmitted to the email of the user assigned to a specific task to validate that only the individual with that email will be viewing and updating the activity.

The processor 102 is then configured to transmit one or more documents pertaining to the requested data to the authenticated user through a transmission module 112, and further tracking a plurality of viewing activities of the user. The processor 102 is further configured to record a plurality of actions of the user through a logging module 114. In an embodiment, the present system 100 provides the data to the user in a predefined template and receives the request from the user in a predefined format.

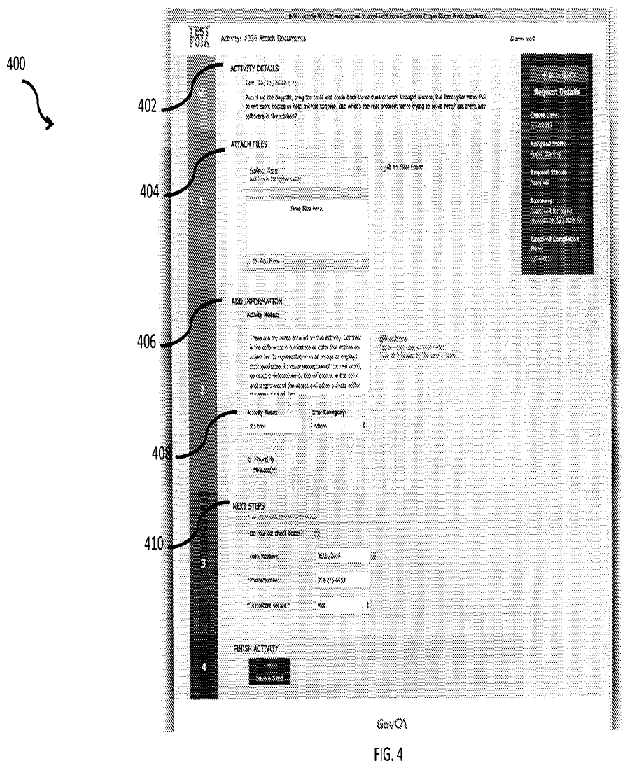

FIG. 4 illustrates an exemplary operational screenshot 400 of an activity web page, in accordance with an embodiment of the present invention. In operation, when the users “login”, they are presented with an activity page customized to the specific task. The logging module 114 logs this information and displays pertinent information such as activity details 402, attach files 404, activity notes 406, activity time 408, next steps 410, etc. for the task. The logging module 114 displays the ability to review the documents. The logging module 114 then prompts the user to enter the necessary information, including documents of any size securely. The user stores the assigned task and sends the information back to the present system so it can be processed. Multiple iterations of this can happen hierarchically until the original request is resolved.

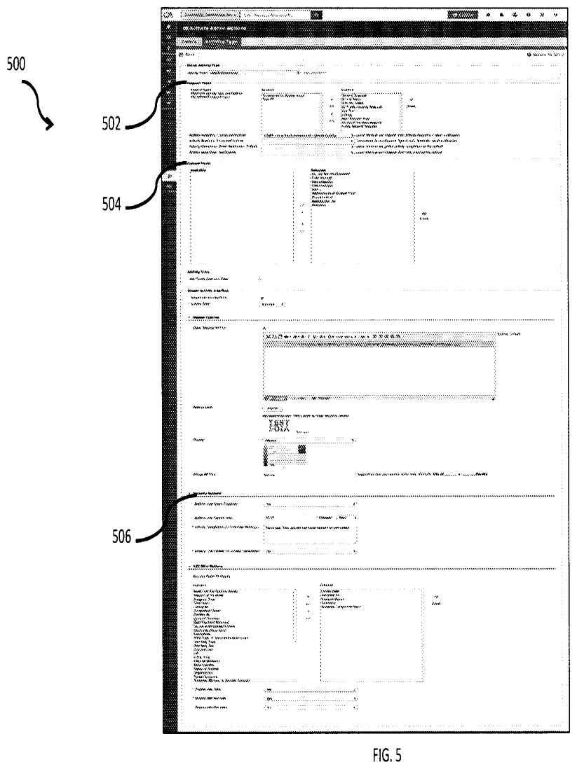

FIG. 5 illustrates an exemplary operational screenshot 500 of a plurality of steps to configure the request, in accordance with an embodiment of the present invention. This configuration indicates each of the steps to provide the information related to the request 502, fields to display 504, security constraints 506, notification methods, etc. can be configured in the screenshot shown in FIG. 5.

In an embodiment, as shown, the activity type can be selected at the top from among a number of different activity types. Each of the activity types can include request types which indicate the kind of information being requested. Custom fields can be selected, as well as the description of the kind of information that is necessary.

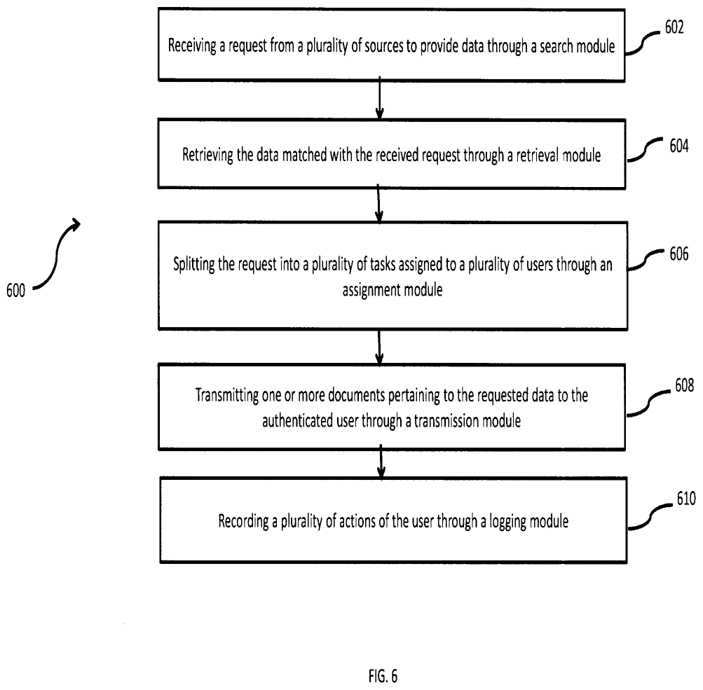

FIG. 6 illustrates a flowchart 600 of the method for secure processing of data, in accordance with an embodiment of the present invention. The method comprises a step 602 of receiving a request from a plurality of sources to provide data through a search module. Then the method comprises a step 604 of retrieving the data matched with the received request through a retrieval module. The data is retrieved from a plurality of resources. The method then includes a step 606 of splitting the request into a plurality of tasks assigned to a plurality of users through an assignment module. The assignment module assigns the task by performing a two-factor authentication by the user through an email. The users receive an email having a link to provide the data pertaining to the task. The link prompts the user to enter a unique code. The unique code is transmitted to the email of the user assigned to a specific task. Furthermore, the method comprises a step 608 of transmitting one or more documents pertaining to the requested data to the authenticated user through a transmission module and tracking a plurality of viewing activities of the user. The method further comprises a step 610 of recording a plurality of actions of the user through a logging module.

Thus, the present system and method provide an efficient, simpler and more elegant platform for handling secure communication that is required for sensitive data and (typically) government organizations. Further, the present invention transmits the information and documents via secure links to authenticate the user, handles the unlimited file sizes, and creates a verbose and immutable audit history

While embodiments of the present disclosure have been illustrated and described, it will be clear that the disclosure is not limited to these embodiments only. Numerous modifications, changes, variations, substitutions, and equivalents will be apparent to those skilled in the art, without departing from the scope of the disclosure, as described in the claims.

What is claimed is:

1. A computer-implemented method for secure processing of data, the method comprising the steps of:
receiving a request in a computer, from a plurality of sources, to provide data through a search module running on the computer;
retrieving the data matched with the request through a retrieval module running on the computer , wherein the data is retrieved from a plurality of resources, including first resources internal to the computer and second resources external to the computer;
splitting the request into a plurality of tasks;
assigning the plurality of tasks to a plurality of users through an assignment module running on the computer,
wherein the assignment module assigns the task by performing a two-factor authentication by the user through an email sent to the user, wherein the user receives an email having a link to provide data pertaining to the task, wherein the link prompts the user to enter a unique code, and wherein the unique code is transmitted to the email of the user assigned to a specific task; and
transmitting one or more documents pertaining to the requested data to the authenticated user through a transmission module running on the computer, and further tracking a plurality of viewing activities of the user.

2. The method according to claim 1, further comprising a step of recording a plurality of actions of the user through a logging module running on the computer.

3. The method according to claim 1, wherein the unique code validates the user and allows the user to view and update the task.

4. The method according to claim 1, where the computer provides the data to the user in a predefined template and receives the request from the user in a predefined format.

5. A system for secure processing of data, the system comprising:
a processor; and
a memory to store machine-readable instructions that when executed by the processor cause the processor to:
receive a request from a plurality of sources to provide data through a search module;
retrieve the data matched with the received request through a retrieval module, wherein the data is retrieved from a plurality of resources;
split the request into a plurality of tasks assigned to a plurality of users through an assignment module, wherein the assignment module assigns the task by performing a two-factor authentication by the user through an email, wherein the user receives an email having a link to provide the data pertaining to the task, wherein the link prompts the user to enter a unique code, and wherein the unique code is transmitted to the email of the user assigned to a specific task;
transmit one or more documents pertaining to the requested data to the authenticated user through a transmission module, and tracking a plurality of viewing activities of the user.

6. The system according to claim 5, further comprising a step of recording a plurality of actions of the user through a logging module

7. The system according to claim 5, wherein the unique code validates the user and allows the user to view and update the task.

8. The system according to claim 5, further comprising operating the computer to provide the data to the user in a predefined template and receive the request from the user in a predefined format.

9. A device in a network, comprising:
a non-transitory storage device having embodied therein one or more routines operable to perform secure processing of data; and
one or more processors coupled to the non-transitory storage device and operable to execute the one or more routines,
wherein the one or more routines executed by the processor include:
a search module to receive a request from a plurality of sources to provide data;
a retrieval module to retrieve the data matched with the received request, wherein the data is retrieved from a plurality of resources;
an assignment module to split the request into a plurality of tasks, and assign the plurality of tasks respectively to a plurality of users,
wherein the assignment module assigns the task by performing a two-factor authentication by the user through an email, wherein the user receives an email having a link to provide the data pertaining to the task, wherein the link prompts the user to enter a unique code, wherein the unique code is transmitted to the email of the user assigned to a specific task; and
a transmission module to transmit one or more documents pertaining to the requested data to the authenticated user, and further track a plurality of viewing activities of the user.

10. The device according to claim 9, further comprises a step of recording a plurality of actions of the user through a logging module.

11. The device according to claim 9, wherein the unique code validates the user and allows the user to view and update the task.

12. The device according to claim 9, provides the data to the user in a predefined template and receives the request from the user in a predefined format.
